(19) United States
(12) Patent Application Publication
(10) Pub. No.: US 2008/0301223 A1
(43) Pub. Date: Dec. 4, 2008

(54) Mobile Apparatus Including Template Based Flash Image Generation Function and Method For Generating Flash Image Using the Same

(75) Inventor: Young Muk Cha, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: MOBIDERS, INC., Seoul (KR)

(21) Appl. No.: 12/096,710

(22) PCT Filed: Sep. 5, 2007
(86) PCT No.: PCT/KR2007/004267

§ 371 Date: Jun. 9, 2008

(30) Foreign Application Priority Data
Sep. 5, 2006 (KR) 10-2006-0084941

(51) Int. Cl. G06F 3/048; G06F 15/16

(52) U.S. Cl. 709/203; 715/764

(57) ABSTRACT

The present invention relates to a mobile apparatus including a template based flash image generation function and method for generating flash image using the same, more particularly, to a technology capable of generating a flash image simply and conveniently on a mobile apparatus without using an exclusive program which uses PC in order to generate a flash image. According to the present invention, provided is a mobile apparatus capable of generating a template based flash image, which includes a key input unit to which a user can input a command; a display unit in which a flash image is displayed; a first memory in which one or more images are stored; a second memory in which a background template, an icon template and an effect template is stored; and a third memory in which a generated flash image is stored, wherein a flash image generating program is stored in one of the first memory, the second memory, the third memory, wherein the mobile apparatus comprises a controller that copies an image selected in the first memory by the key input unit and the background template and the icon template selected in the second memory by the key input unit altogether into the effect template, and generating the effect template into a flash image by using the flash image generating program to store in the third memory.

### TECHNICAL FIELD

The present invention relates to a mobile apparatus including a template based flash image generation function and method for generating flash image using the same, more particularly, to a technology capable of generating a flash image simply and conveniently on a mobile apparatus without using an exclusive program which uses PC in order to generate a flash image.

### BACKGROUND ART

As usual, the flash image of the SWF type is a flash movie file, and the extension after a file name is ‘swf’. The flash image of the SWF type having the ‘swf’ extension can be played on Internet in a computer in which a browser or a plug-in is installed. In the meantime, the flash image file of the FLA type is a file which can be modified or deleted, and the extension after the file name is ‘fla’. Here, the file which is shown to people is a flash image file of the SWF type. The flash image file of the SWF type is published as the exclusive program compiles a file of the FLA type.

FIG. 4 is a drawing showing the screen capture of the Macromedia Flash Professional 8 which is a program compiling a file of the FLA type to the file of the SWF type.

Referring to FIG. 4, the reference numeral 135 designates the flash image file name of the FLA type, and the reference numeral 136 designates the menu that has the function of inserting the new object or the dynamic effect into the flash image file of the FLA type. The reference numeral 137 designates the menu for editing the flash image file of the FLA type, and the reference numeral 138 designates the menu which opens or stores the flash image file of the FLA type. The reference numeral 134 shows the layer of the element forming the flash image.

As usual, in order to make the flash image file of the SWF type which is a file shown to people, the flash image file of the FLA type should be generated by using an exclusive program like the Macromedia Flash Professional 8 in PC, thereafter, the generated flash image file of the FLA type is compiled as a flash image file of the SWF type for publishing.

Therefore, modifying or generating the flash image file was only possible in PC or the like, in which the exclusive program having such complicated function and relatively large capacity can be drived. Thus, since it is difficult to install the exclusive program in a portable apparatus such as mobile communications terminal, PMP, MP3, the flash image file cannot be modified or generated. Therefore, there is a problem in that the flash image having the initially stored type can not be corrected and should be used as it is.

### DISCLOSURE

Technical Problem

Accordingly, an object of the present invention is to solve at least the problems and disadvantages of the background art, and to provide a mobile apparatus which is capable of generating a template based flash image by transforming the image photographed on the mobile apparatus or downloaded from the outside into a flash image which has the various and dynamic effect by using the background template and the icon which is already provided. Furthermore, the present invention aims at providing a flash image generating method using the mobile apparatus.

Technical Solution

In order to accomplish the object, according to an aspect of the present invention, provided is a mobile apparatus capable of generating a template based flash image, which includes a key input unit by which a user can input a command; a display unit in which a flash image is displayed; a first memory in which one or more images are stored; a second memory in which a background template, an icon template and an effect template is stored; and a third memory in which a generated flash image is stored, wherein a flash image generating program is stored in one of the first memory, the second memory or the third memory, the mobile apparatus comprising: a controller that copies an image selected from the first memory by the key input unit and the background template and the icon template selected from the second memory by the key input unit altogether into the effect template, generates a flash image from the effect template by using the flash image generating program, and stores the flash image in the third memory

In accordance with an aspect of the present invention, the mobile apparatus further comprises a transceiver processor which sends and receives wireless signals with a server in order to download an image for storing in the first memory from the server.

In accordance with an aspect of the present invention, the mobile apparatus further comprises an interface unit which sends and receives a data with an external device in order to download an image for storing in the first memory from the external device.

According to an aspect of the present invention, in the effect template, the flash image is stored in the second memory as a binary code form or a text form.

In the effect template, the flash image is stored in a memory region of the flash image generating program stored in the first memory as one of a binary code form or a text form.

The format of the background template, the icon template, the effect template and the image is one of SVG (Scalable Vector Graphic) format, VIS(Vector Image Solution) format and DMF(DigitalAria Mobile Format) format. According to another aspect of the present invention, provided is a method of generating a template based flash image by using a mobile apparatus that includes a key input unit by which a user can input a command; a display unit in which a flash image is displayed; a first memory in which one or more images are stored; a second memory in which a background template, an icon template and an effect template is stored; and a third memory in which a generated flash image is stored, wherein a flash image generating program is stored in one of the first memory, the second memory or the third memory, the method comprising the steps of: a) copying an image selected from the first memory by the key input unit and the background template and the icon template selected from the second memory by the key input unit altogether into the effect template; and b) generating from the effect template a flash image through the flash image generating program to store the flash image in the third memory.

The a) step comprises the steps of: a-1) temporarily storing the image of the first memory selected by the key input unit into the third memory; a-2) temporarily storing the background template and the icon template stored in the second memory into the third memory; a-3) loading the effect template stored in the second memory; a-4) copying the image which is temporarily stored in the third memory into the image portion of the effect template that is loaded from the second memory; and a-5) temporarily storing the effect template into the third memory by copying the background template and the icon template which are temporarily stored in the third memory into the background part and the icon part of the effect template respectively.

Here, further comprising the steps of: a-6) copying the text inputted by the key input unit into the text part of the effect template; and a-7) temporarily storing the effect template into the third memory by adding a frame as much as a set display time which is set up by the key input unit.

In the mean time, the b) step comprises the steps of: b-1) analyzing the effect template which is temporarily stored in the third memory unit to make a flash image header, and temporarily storing the flash image header into the third memory unit; b-2) converting the effect template which is temporarily stored into a flash image form; b-3) copying the effect template transformed into the flash image form after the flash image header which is temporarily stored in the third memory unit, and generating the flash image; b-4) storing the generated flash image into the third memory.

Advantageous Effects

According to the present invention having the configuration as described above, in order to generate a flash image in a mobile apparatus, without using a complicated exclusive program having relatively large capacity in PC, just by using a simple flash image generating program having relatively small capacity which has only the function of generating a template based flash image on the mobile apparatus, the flash image can be generated simply and conveniently. Further, the present invention has the effect that the generated flash image can be transmitted to other mobile apparatus, sent by using e-mail or uploaded to an internet board, so that it is easy to deliver an information.

### BRIEF DESCRIPTION OF THE DRAWINGS

FIG. 1 is a block diagram showing the configuration of the mobile apparatus having the function of generating the template based flash image of the present invention;

FIG. 2 is a flowchart of a generating method of the template based flash image of the present invention;

FIG. 3 is a flowchart showing the method for copying an image, a background template and an icon template into an effect template in a generating method of a template based flash image of the present invention;

FIG. 4 is a drawing of screen capture of the Macromedia Flash Professional 8;

FIG. 5 is a conceptual diagram showing an embodiment of copying an image, a background template, an icon template and a text into an effect template;

FIG. 6 is a conceptual diagram showing an embodiment of an effect template and a new effect template which is expanded;

FIG. 7 is a conceptual diagram showing a display applying a set display time to an effect template; and

FIG. 8 is a capture diagram showing a display in which the generated flash image is expressed.

### BEST MODE

Hereinafter, the configuration of the present invention will be illustrated in detail with reference to the attached drawing.

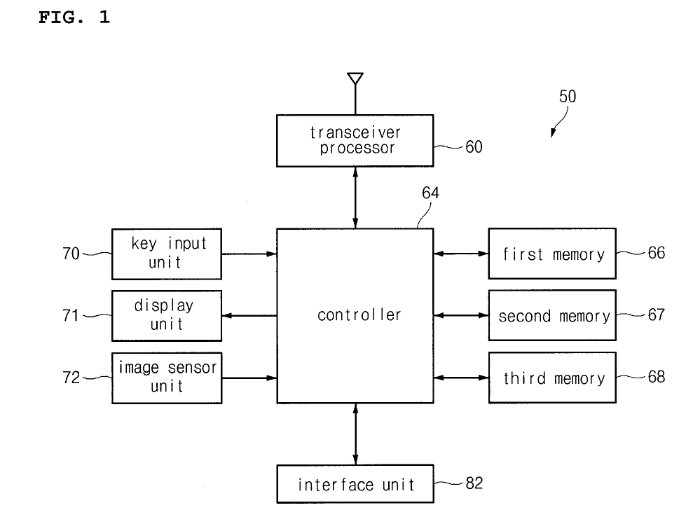

FIG. 1 is a block diagram showing the configuration of a mobile apparatus having the function of generating a template based flash image of the present invention.

As shown in FIG. 1, a mobile apparatus 50 having the function of generating the template based flash image of the present invention includes a key input unit 70, a display unit 71, a first, a second, a third memory 66,67,68, an image sensor unit 72, a controller 64, a transceiver processor 60 and an interface unit 82.

Firstly, in the present invention, a template in this specification means a data frame having a given configuration, in which a specific data such as an image, an icon and a background can be inputted in the data frame. Additionally, the mobile apparatus 50 is preferably a multimedia terminal including a mobile communications terminal, PMP(portable multimedia player), MP3 player. Hereinafter, each element of the mobile apparatus 50 according to the present invention will be illustrated in detail.

A plurality of key buttons are prepared in the key input unit 70, and, by which, a user can input a command. Through the key input unit 70, a user can select an image in the first memory 66, can select a background template and an icon template in the second memory 67, can input various words in text base, and can input a set display time on which each flash image of the present invention is to be displayed. The display unit 71 made of LCD displays a generated flash image. In addition to displaying the generated flash image, the display unit 71 displays how to select the image in the first memory 66, and how to select the background template and the icon template in the second memory 67, and how to input various words and the set display time, so that the user can manipulate the key button of the key input unit 70 while looking at the display unit 71.

Here, the person skilled in the art will be able to easily understand that the display unit 71 can be comprised of a touch pad.

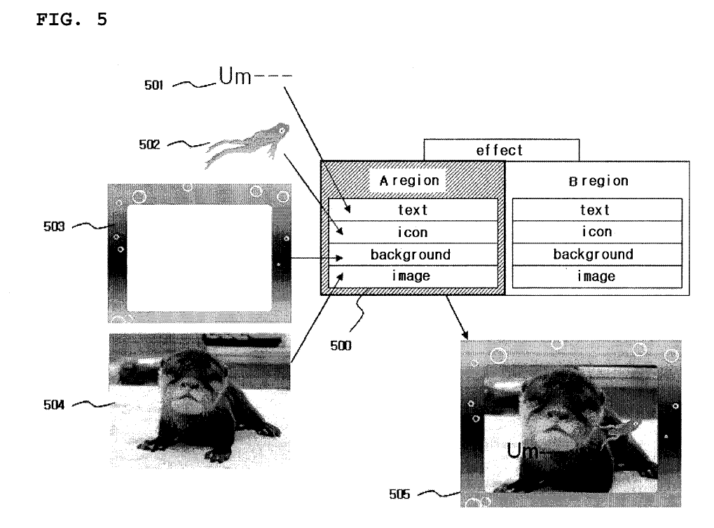

The first memory 66 serves as the storage in which a flash image generating program which is operated under the control of the controller 64 is stored together with one or more images 504, refer to FIG. 5. Of course, it may be acceptable that the flash image generating program can be stored in memory among the first, the second, the third memory 66, 67, 68.

Here, the image 504 stored in the first memory 66 can be an image photographed by the mobile apparatus 50, for this, the mobile apparatus includes the image sensor unit 72. Accordingly, the image 504 photographed by the image sensor unit 72 can be selected through the key input unit 50 to be displayed to the display unit 71, or the image 504 can be stored in the first memory 66.

Further, the image 504 stored in the first memory 66 can be an image 504 which has been stored in a specific server. Therefore, the mobile apparatus 50 additionally includes the transceiver processor 60 which sends and receives wireless signals with the server in order to download the image 504 which will be stored in the first memory 66 from the specific server. Further, the image 504 stored in the first memory 66 can be an image 504 which has been stored in the external device including another mobile apparatus or PC. Therefore, the mobile apparatus 50 additionally includes an interface unit 82 which transmits and receives a data with the external device in order to download the image 504 which will be stored in the first memory 66 from the external device.

In the meantime, the mobile apparatus 50 can transmit the flash image 504 generated by the controller 64 which will be described later to the mobile apparatus 50 or PC by using the transceiver processor 60 and the interface unit 82, or can transmit the generated flash image 504 to others' mail account by attaching it to an e-mail or can register it in the bulletin board of a specific internet site by connecting to an internet through the transceiver processor 60.

In the meantime, referring to FIG. 5, the second memory 67 serves as a storage in which a background template 503, an icon template 502 and an effect template 505 are stored. The background template 503, the icon template 502 and the effect template 505 stored in the second memory can be made with one of the formats among the SVG(Scalable Vector Graphic) format which is a general vector image, the VIS (Vector Image Solution) format which is a vector graphic image of Neomtel corp. or DMF (DigitalAria Mobile Format) format which is a vector graphics image of DigitalAria corp. as well as with the flash image of the Adobe corp.

Here, the effect template 505 can be a file in which the flash image is manufactured as a binary code form or a text form and stored in the second memory. And in another embodiment, the effect template 505 can be a file in which the flash image is manufactured as a binary code form or a text form and stored in the memory area of the flash image generating program. In the meantime, the third memory 68 serves as a storage in which the flash image generated by the controller 64 which will be described later is stored. Here, it is possible that the first, the second, the third memory 66, 67, 68 can be formed into one memory unit and can be divided, or can be formed into each individual memory units.

In the meantime, the controller 64 reads out the images or the templates which are selected by a user through the key input unit 70 from the first, the second, the third memory 66, 67, 68 correspondingly, and as shown in FIG. 5, it plays the role of copying the image, the background template, the icon template and the text into the image portion, the background portion, the icon portion, the text portion of the effect template 505. Further, as described above, the controller 64 plays the role of compiling the effect template 505 in which an image 504, the background template 503, the icon template 502 and a text 501 have been copied to generate the flash image by controlling the flash image generating program. The template based flash image generating method using the mobile apparatus 50 in the above statement will be illustrated with reference to the attached drawings.

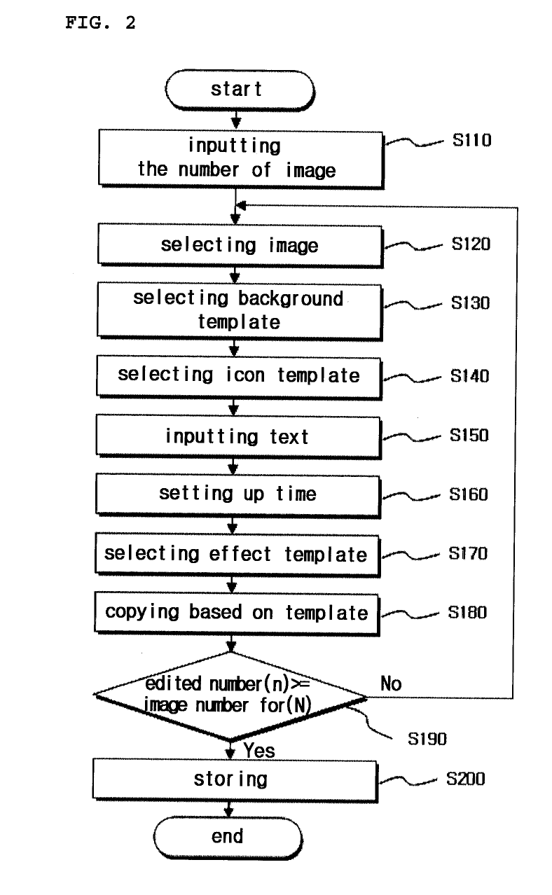

As shown in FIG. 2, firstly, in case the mobile apparatus is turned on, by a user through the key input unit 70, the controller 64 receives the number of image 504 (S110), selecting the image stored in the first memory 66 (S120), selecting the background template 503 and the icon template 502 which are stored in the second memory 67 (S130, 140), and inputting the text 501 (S150) . In case the number of image which is inputted at step S110 and selected at step S120 is two or more, the user sets up the set display time in order to adjust the image display interval (S160), selecting the effect template stored in the second memory 67 (S170), copying the selected image 504, the background template 503, the icon template 502 and the text 501 into the corresponding part of the effect template 505 respectively (S180).

The number N of image 504 for editing that a user inputted at the step 110 is compared with the number n of image 504 which has been actually edited (S190). In case the number n of image 504 which has been actually edited is equal to or greater than the image 504 number N for editing that the user inputted, then, the effect template 505 is formed into the flash image and stored in the third memory unit 68 (S200). Here, at the step S190, in case the number n of actually edited image 504 is less than the number N of image for editing that the user inputted, it again returns to the step S120 and proceeds to the next step.

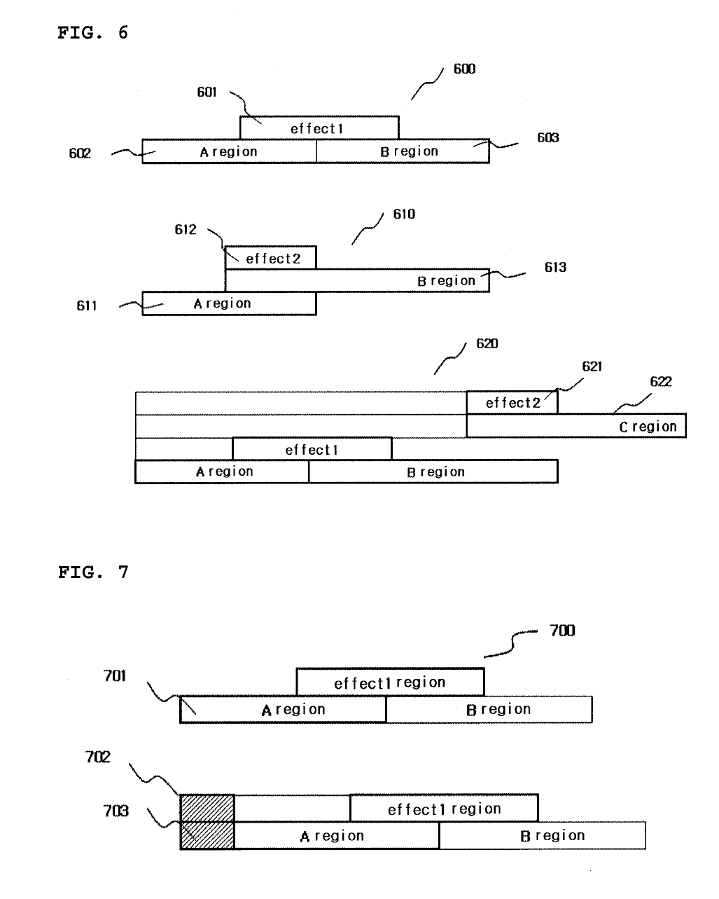

Here, referring to FIGS. 5 and 6, the number of images 504 can be comprised of one or more regions in which the image part, the icon part, the background part, the text part are independently given to each region like A region, B region, and C region on the inside of one effect template 505. That is, on the inside of one effect template 505, there can be only A region, or can be A region, B region, and C region altogether. In case of the effect template 505 in which A region, B region, and C region altogether exist, three images can be edited.

Therefore, in expressing one effect template 505, the slide change is performed from A region to B region, and again from B region to C region in the effect template 505, and the time in which each region is shown in the slide change is called as a set display time. In conclusion, in case the set display time is a five second, A region is shown during five seconds, and then, B region is shown during five seconds.

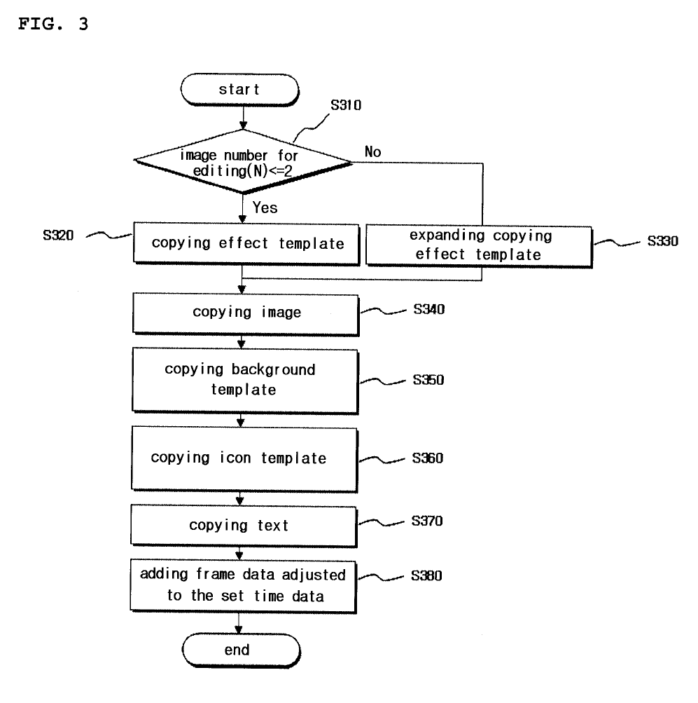

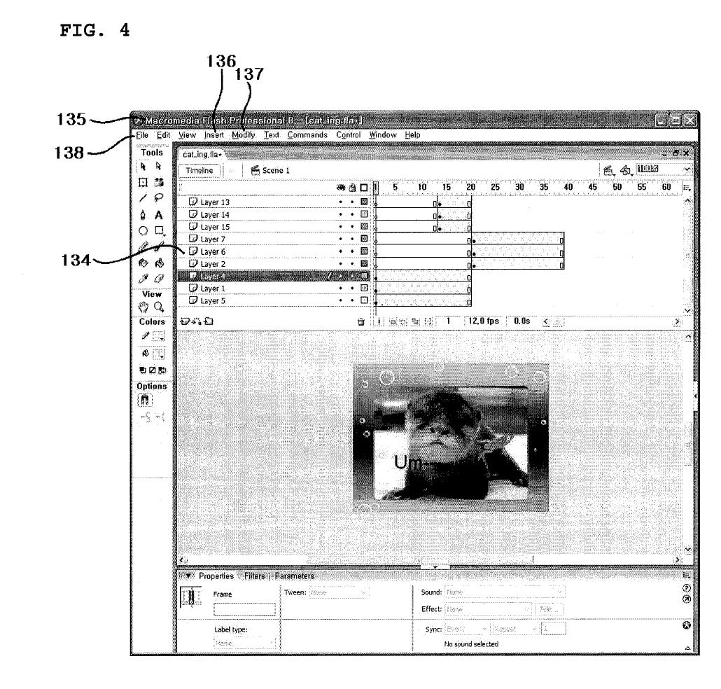

In the meantime, in considering the step 180 in detail, as shown in FIG. 3, the image 504 of the first memory 66 in which the number of image to be edited by the key input unit 70 is inputted and selected is temporarily stored in the third memory unit 68. The background template 503 and the icon template 502 stored in the second memory 67 are temporarily stored in the third memory unit 68. In case the number of image for editing which is inputted By the key input unit 70 is two or less, then, immediately, the effect template stored in the second memory 67 is loaded (S320).

Here, in case the number of image for editing which is inputted by the key input unit 70 is two or more, the selected effect templates 505 are copied to generate a new expanded effect template 505 for loading (S330), and the image 504 which has been temporarily stored in the third memory unit 68 is copied into the image 504 part of the effect template 505 which is loaded in the second memory 67 (S340).

Additionally, the background template 503 and the icon template 502 which have been temporarily stored in the third memory unit 68 are copied into the background part and the icon part of the effect template 505 respectively (S350, S360) . The text 501 inputted by the key input unit 70 is copied into the text part of the effect template 505 (S370) . A frame is added into the effect template 505 as much as the set display time which is set up by the key input unit 70 (S380), and it is temporarily stored in the third memory unit 68.

In the meantime, in considering the step S200 in detail, a flash image header is generated by analyzing the effect template 505 which has been temporarily stored in the third memory unit 68 and the flash image header is temporarily stored in the third memory unit 68. The effect template 505 which is temporarily stored is converted into the form of flash image. The effect template 505 transformed into the form of flash image is copied after the flash image header which has been temporarily stored in the third memory unit 68 to generate a flash image. The generated flash image is stored in the third memory unit 68.

In the meantime, in considering the step S330 in detail, for instance, in case just only A region and B region exist in the first effect template while the image for editing is, for instance, five, three or more effect template are required. In conclusion, the effect templates in which the five photographs are included have to be connected.

As shown in FIG. 6, by using a first effect template 600 and a second effect template 610, a new third effect template 620 in which the first effect template 600 and the second effect template 610 are connected is made.

Accordingly, as to the third effect template 620, in order that the first effect template 600 and the second effect template 610 be connected, A region and B region of the first effect template 600 are reflected in the new third effect template 620 without a change. A region of the second effect template 610 is overlapped with A region of the first effect template 600, thus, it is removed and not be reflected. B region of the second effect template 610 is changed into C region of the third effect template 620 to be reflected.

Accordingly, the image of A region and B region of the first effect template 600, and the image of B region of the second effect template 610 are reflected into A, B, C region of the third effect template 620, so that total five images, a text, and an icon can be altogether processed in one screen as three images, a text, and an icon.

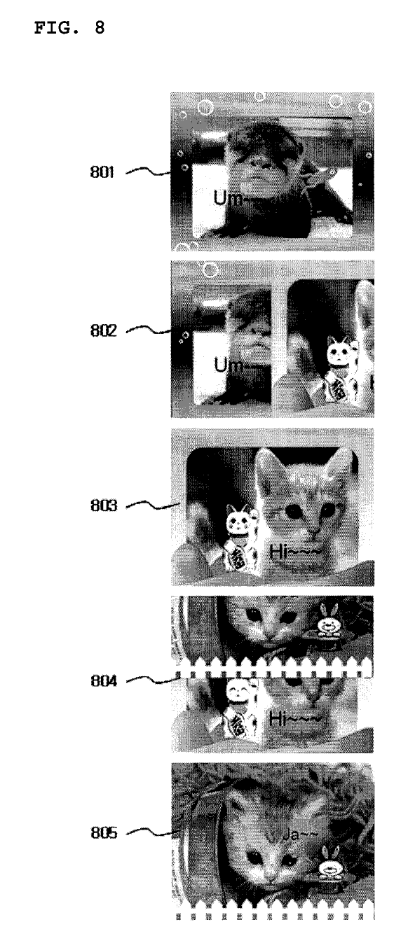

In the meantime, in considering the step S170 in detail, as shown in FIG. 7, after an effect template 700 is copied in the second memory 67, the time can be increased or reduced by adding a frame 702 on the part for setting up the time. A region 701 is an effect template data before increasing or reducing the time. A region 703 in which the set up time is applied is an effect template data in which the time is increased as much as a time set up 702.

In the meantime, FIG. 8 is a capture diagram showing a display in which the flash image that is generated at step S200 is expressed. As to the flash image denoted by numerals 801, 803, and 805, the image 504, the background template 503, the icon template 502 and the text 501 are displayed based on the effect template 505.

Further, the flash image denoted by numerals 801, 803 shows the effect that the flash image is slided from the right to the left in an interval of the set display time that a user sets up at step S160 through the key input unit 70. The flash image denoted by numeral 804 shows the effect that the flash image is slided from the top to the bottom in an interval of the set display time that a user sets up at step S160 through the key input unit 70.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### Industrial Applicability

The present invention can be used for a mobile terminal having a flash image generating function.

1. A mobile apparatus capable of generating a template based flash image, which includes a key input unit by which a user can input a command; a display unit in which a flash image is displayed; a first memory in which one or more images are stored; a second memory in which a background template, an icon template and an effect template is stored; and a third memory in which a generated flash image is stored, wherein a flash image generating program is stored in one of the first memory, the second memory or the third memory, the mobile apparatus comprising:
a controller that copies an image selected from the first memory by the key input unit and the background template and the icon template selected from the second memory by the key input unit altogether into the effect template, generates a flash image from the effect template by using the flash image generating program, and stores the flash image in the third memory.

2. The mobile apparatus of claim 1, further comprising a transceiver processor which sends and receives wireless signals with a server in order to download an image for storing in the first memory from the server.

3. The mobile apparatus of claim 1, further comprising an interface unit which sends and receives a data with an external device in order to download an image for storing in the first memory from the external device.

4. The mobile apparatus of claim 1, wherein, in the effect template, the flash image is stored in the second memory as a binary code form or a text form.

5. The mobile apparatus of claim 1, wherein, in the effect template, the flash image is stored in a memory region of the flash image generating program stored in the first memory as one of a binary code form or a text form.

6. The mobile apparatus of claim 1, wherein the format of the background template, the icon template, the effect template and the image is one of SVG(Scalable Vector Graphic) format, VIS(Vector Image Solution) format and DMF(DigitalAria Mobile Format) format.

7. A method of generating a template based flash image by using a mobile apparatus that includes a key input unit by which a user can input a command; a display unit in which a flash image is displayed; a first memory in which one or more images are stored; a second memory in which a background template, an icon template and an effect template is stored; and a third memory in which a generated flash image is stored, wherein a flash image generating program is stored in one of the first memory, the second memory or the third memory, the method comprising the steps of:
a) copying an image selected from the first memory by the key input unit and the background template and the icon template selected from the second memory by the key input unit altogether into the effect template; and
b) generating from the effect template a flash image through the flash image generating program to store the flash image in the third memory.

8. The method of claim 7, wherein the a) step comprises the steps of:
a-1) temporarily storing the image of the first memory selected by the key input unit into the third memory;
a-2) temporarily storing the background template and the icon template stored in the second memory into the third memory;
a-3) loading the effect template stored in the second memory;
a-4) copying the image which is temporarily stored in the third memory into the image portion of the effect template that is loaded from the second memory; and
a-5) temporarily storing the effect template into the third memory by copying the background template and the icon template which are temporarily stored in the third memory into the background part and the icon part of the effect template respectively.

9. The method of claim 8, further comprising the steps of:
a-6) copying the text inputted by the key input unit into the text part of the effect template; and
a-7) temporarily storing the effect template into the third memory by adding a frame as much as a set display time which is set up by the key input unit.

10. The method of claim 7, wherein the b) step comprises the steps of:
b-1) analyzing the effect template which is temporarily stored in the third memory unit to make a flash image header, and temporarily storing the flash image header into the third memory unit;
b-2) converting the effect template which is temporarily stored into a flash image form;
b-3) copying the effect template transformed into the flash image form after the flash image header which is temporarily stored in the third memory unit, and generating the flash image; and
b-4) storing the generated flash image into the third memory.

11. The method of claim 8, wherein the b) step comprises the steps of:
b-1) analyzing the effect template which is temporarily stored in the third memory unit to make a flash image header, and temporarily storing the flash image header into the third memory unit;
b-2) converting the effect template which is temporarily stored into a flash image form;
b-3) copying the effect template transformed into the flash image form after the flash image header which is temporarily stored in the third memory unit, and generating the flash image; and
b-4) storing the generated flash image into the third memory.

12. The method of claim 9, wherein the b) step comprises the steps of:
b-1) analyzing the effect template which is temporarily stored in the third memory unit to make a flash image header, and temporarily storing the flash image header into the third memory unit;
b-2) converting the effect template which is temporarily stored into a flash image form;
b-3) copying the effect template transformed into the flash image form after the flash image header which is temporarily stored in the third memory unit, and generating the flash image; and
b-4) storing the generated flash image into the third memory.
